(19) United States
(12) Patent Application Publication
(10) Pub. No.: US 2004/0212594 A1
(43) Pub. Date: Oct. 28, 2004

(54) Method of rapid processing in a keypad connected to an electronic device

(75) Inventors: Yen-Chun Wu, Shu Lin City (TW); Li-Chun Huang, Chung Ho City (TW)

Correspondence Address: BACON & THOMAS, PLLC, 625 SLATERS LANE, FOURTH FLOOR, ALEXANDRIA, VA, 22314

(73) Assignee: ORtek Technology, Inc., Chung Ho City (TW)

(21) Appl. No.: 10/419,744

(22) Filed: Apr. 22, 2003

(51) Int. Cl. G09G 5/00

(52) U.S. Cl. 345/168

(57) ABSTRACT

The present invention is to provide a method of rapid processing in a keypad connected to an electronic device, which enables the keypad to send a default meaning of a key code of the keypad to the electronic device depending on a state of the keypad while a send key of the keypad is pressed, irrespective of the keypad being in the auxiliary keyboard mode or the calculator mode, value shown on a display of the keypad will then be sent to a current cursor's location on a display of the electronic device as the electronic device is running an application program, thereby enabling a user to edit a document.

### FIELD OF THE INVENTION

The present invention relates to methods of processing in a peripheral connected to an electronic device and more particularly to a method of rapid processing (e.g., editing) in a keypad connected to an electronic device (e.g., notebook or personal computer).

### BACKGROUND OF THE INVENTION

A Taiwanese Patent Application No. 90,120,131 entitled “Method Rapid Processing in A Keypad Connected To An Electronic Device” as filed by the present inventor disclosed a keypad as an auxiliary keyboard of a keyboard of an electronic device without installing a driver in the electronic device. That is, the keypad is a Plug and Play device. As such, a number lock (Number Lock) key of the keypad, irrespective of being locked or not, will not affect state of a Number Lock key of the keyboard of the electronic device. At the same time, the keypad, depending on its state, is adapted to send a default meaning of a key code to the electronic device.

However, the prior art suffered from a disadvantage. For example, in operating a computer it is often that a user has the need of using a calculator mode for calculation and sending result of the calculation to the computer for editing by running an application program.

Thus, it is desirable to provide a powerful keypad connected to an electronic device capable of performing an additional calculator mode so that a user can select to switch the keypad to an auxiliary keyboard mode or a calculator mode in order to overcome the above drawback of the prior art.

### SUMMARY OF THE INVENTION

A primary object of the present invention is to provide a method of rapid processing in a keypad connected to an electronic device, the keypad having an embedded calculator. By utilizing this, the above drawback of the prior art (i.e., no provision of calculator mode causing troubles to a user in editing documents) can be overcome.

In one aspect of the present invention a keypad connected to an electronic device can be used as a Plug and Play type device of the electronic device without installing a driver in the electronic device. Irrespective of a Number Lock key of the keyboard of the electronic device being in an on or off state, an interaction between the Number Lock keys of the keypad and the keyboard will not be generated. The keypad is able to send a default meaning of a key code of the keypad to the electronic device depending on a state of the keypad. Also, once a send key of the keypad is pressed, irrespective of the keypad being in the auxiliary keyboard mode or the calculator mode, value shown on a display of the keypad will be sent to a current cursor's location as the electronic device is running an application program, thereby enabling a user to edit a document.

In another aspect of the present invention in a case that the keypad is at the calculator mode, a first pressing of a Number Lock key of the keypad will clear the last input value (i.e., function key of CE on a typical calculator). Further, a second pressing of the Number Lock key of the keypad will switch it to a reset key (i.e., function key of reset of a typical calculator) for clearing all internal memory. In another case that the keypad is at the auxiliary keyboard mode the Number Lock key of the keypad is used as a function key of Number Lock (e.g., Number Lock key of a typical keyboard). Moreover, in the above case that the keypad is at the calculator mode, an Enter key of the keypad is operative to be equal to “=” key. When the keypad is in the auxiliary keyboard mode, the Enter key thereof will be used as a function key of input confirmation. In addition, in a case that a user runs an application program (e.g., Excel) and a “−” key is pressed the keypad can solve the problem of incorrect action caused by not complying with state of the Number Lock key of the keypad. For example, when the keypad is in an ON state prior to running an application program (e.g., Excel), a first pressing of “−” will show a “−” rather than an erroneous extension EXT The above and other objects, features and advantages of the present invention will become apparent from the following detailed description taken with the accompanying drawings.

### BRIEF DESCRIPTION OF THE DRAWINGS

FIG. 1 is a perspective view of a preferred embodiment of a keypad connected to an electronic device according to the invention;

FIG. 2 is a block diagram of the keypad and the electronic device; and

FIG. 3 is a flow chart showing a sequence of method steps performed by the keypad according to the invention.

### DETAILED DESCRIPTION OF THE PREFERRED EMBODIMENTS

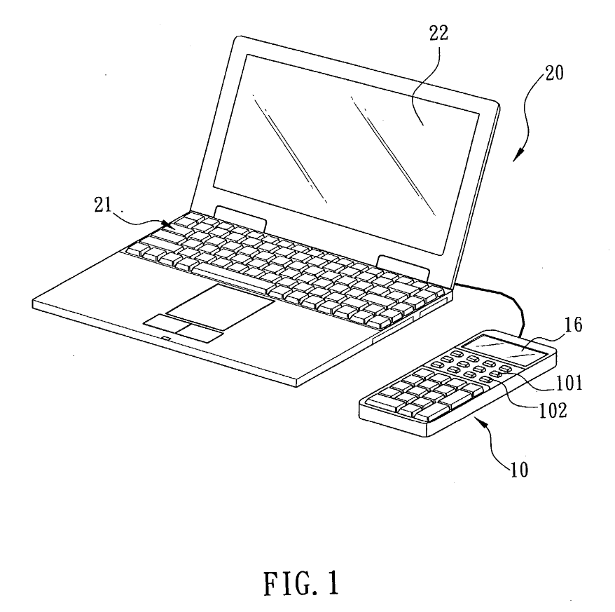

Referring to FIG. 1, there is shown a keypad 10 connected to an electronic device 20 in accordance with the invention. The keypad 10 has an auxiliary keyboard mode and a calculator mode. The electronic device 20 can be implemented as a notebook computer (in this embodiment) or personal computer. Once the connection of the keypad 10 to the electronic device 20 is established, the keypad 10 can be used as an auxiliary keyboard of a keyboard 21 of the electronic device 20 without installing a driver in the electronic device 20. That is, the keypad 10 is a Plug and Play device of the electronic device 20. When a Number Lock key of the keypad 10 is in an ON state, irrespective of a Number Lock key of the keyboard 21 of the electronic device 20 being in an ON or OFF state, an interaction between the Number Lock keys of the keypad 10 and the keyboard 21 will not be generated and a sending of a default meaning of a key code of the keypad 10 will not be adversely affected.

When a mode switch key 101 of the keypad 10 is pressed to switch to a calculator mode, an operation of a calculator embedded in the keypad 10 can be carried out. Also, once a send key 102 of the keypad 10 is pressed, irrespective of the keypad 10 being in the auxiliary keyboard mode or the calculator mode, value shown on a display 16 of the keypad 10 will be sent to a current cursor's location on a display 22 of the electronic device 20 as the electronic device 20 is running an application program. As such, a user is able to edit a document. The keypad 10 comprises the mode switch key 101, the send key 102, the display 16, etc. A user can press the mode switch key 101 to switch to the auxiliary keyboard mode or the calculator mode available by the keypad 10. At the same time, result (e.g., value) of an operation performed by the calculator of the keypad 10, as shown on the display 16, can be sent to a current cursor's location of the display 22 of the electronic device 20 as the electronic device 20 is running an application program in response to a pressing of the send key 102. As such, a user is able to edit a document. Hence, a purpose of rapidly switching the keypad 10 to the auxiliary keyboard mode or the calculator mode can be obtained by successively pressing the mode switch key 101.

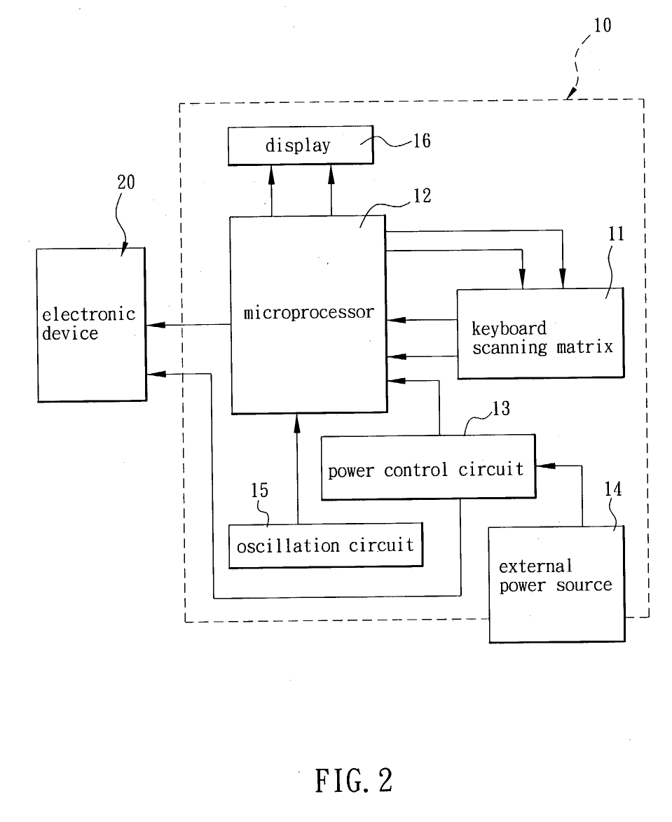

Referring to FIG. 2, in the invention a circuitry of the keypad 10 comprises a keyboard scanning matrix 11 for receiving and performing a predetermined instruction, and a microprocessor 12 for controlling a normal operation of the keypad 10 and associated electronic components in the keypad 10 and sending a default meaning of a key code of the keypad 10 to the electronic device 20 so that the electronic device 20 is able to operate normally. The sending of default meaning of the key code can be carried out via an interface (e.g., Universal Serial Bus (USB), bus structure adopted by IBM, or the like). The circuitry of the keypad 10 further comprises a power control circuit 13 for switching power of the keypad 10 to either connect to the electronic device 20 in response to a connection of the keypad 10 and the electronic device 20 or connect to an external power source 14 in response to a disconnection of the keypad 10 and the electronic device 20. In a latter case, the keypad 10 is allowed to perform the calculator mode only. The circuitry of the keypad 10 further comprises an oscillation circuit 15 for providing a timing clock to the microprocessor 12. The oscillation circuit 15 is also able to increase voltage by three (3) times for supplying sufficient power to the display 16.

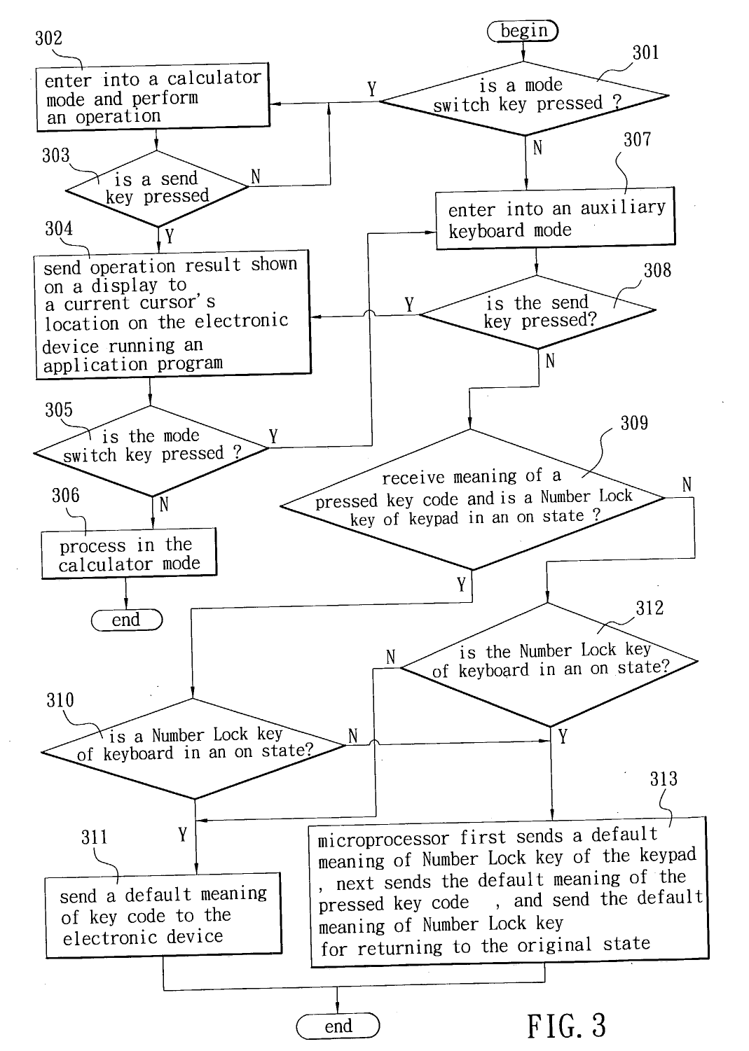

Referring to FIG. 1 again, once the connection of the keypad 10 to the electronic device (e.g., notebook computer) 20 is established via an interface, the keypad 10 is able to perform the following steps in response to a user's operation. These steps are illustrated in a flow chart of FIG. 3.

Step 301: First, the microprocessor 12 determines whether the mode switch key 101 is pressed to switch the keypad 10 to the calculator mode. If yes, the process goes to step 302. Otherwise, the process jumps to step 307.

Step 302: Enter into the calculator mode. Receive digit input and perform an operation such as addition, subtraction, multiplication, or division.

Step 303: The microprocessor 12 determines whether the send key 102 is pressed. If yes, the process goes to step 304. Otherwise, the process loops back to step 302.

Step 304: Result (e.g., value) of an operation shown on the display 16 is directly sent to a current cursor's location on the display 16 of the electronic device 20 as the electronic device 20 is running an application program. As such, a user is able to edit a document.

Step 305: The microprocessor 12 then determines whether the mode switch key 101 is pressed to switch the keypad 10 to the auxiliary keyboard mode. If yes, the process jumps to step 307. Otherwise, the process goes to step 306.

Step 306: Perform a normal processing in the calculator mode.

Step 307: Enter into the auxiliary keyboard mode (i.e., keypad 10 mode).

Step 308: It is determined whether the send key 102 is pressed. If yes, the process loops back to step 304. Otherwise, the process goes to step 309.

Step 309: The keyboard scanning matrix 11 receives meaning of a pressed key code. Further, the microprocessor 12 determines whether a Number Lock key of the keypad 10 is in an ON state. If yes, the process goes to step 310. Otherwise (i.e., the Number Lock key of the keypad 10 is in an OFF state), the process jumps to step 312.

Step 310: It is determined whether a Number Lock key of the keyboard 21 of the electronic device 20 is in an ON state. If yes, the process goes to step 311. Otherwise (i.e., the Number Lock key of the keyboard 21 of the electronic device 20 in an OFF state), the process jumps to step 313.

Step 311: Directly send a default meaning of a key code (e.g., 0-9, +, −, *, /) to the electronic device 20 for normal processing.

Step 312: It is further determined whether the Number Lock key of the keyboard 21 of the electronic device 20 is in an ON state. If yes, the process goes to step 313. Otherwise (i.e., the Number Lock key of the keyboard 21 of the electronic device 20 in an OFF state), the process loops back to step 311.

Step 313: The microprocessor 12 first sends a default meaning of a Number Lock key of the keypad 10 to the electronic device 20 for commanding the Number Lock key of the keyboard 21 to be in a ready to receive state. Next, the microprocessor 12 sends the default meaning of the key code to the electronic device 20. Finally, the microprocessor 12 sends a default meaning of a Number Lock key for causing the Number Lock key of the keyboard 21 to return to its original state for normal processing.

In view of the above, the method of the invention can enable a user to switch the keypad to be in either an auxiliary keyboard mode or a calculator mode for rapid editing. At the same time, when the keypad 10 is at the calculator mode, a first pressing of a Number Lock key of the keypad 10 will clear the last input value (i.e., function key of CE on a typical calculator). Further, a second pressing of the Number Lock key of the keypad 10 will switch it to a reset key (i.e., function key of reset of a typical calculator) for clearing all internal memory. Moreover, an Enter key of the keypad 10 is operative to be equal to “=” key. When the keypad 10 is in the auxiliary keyboard mode, the Enter key thereof will be used as a function key of input confirmation. In addition, in a case that a user runs an application program (e.g., Excel) and a “−” key is pressed the keypad 10 can solve the problem of incorrect action caused by not complying with state of the Number Lock key of the keypad 10. For example, when the keypad 10 is in an ON state prior to running an application program (e.g., Excel), a first pressing of “−” will show a “−” rather than an erroneous extension EXT

While the invention has been described by means of specific embodiments, numerous modifications and variations could be made thereto by those skilled in the art without departing from the scope and spirit of the invention set forth in the claims.

What is claimed is:

1. A method of rapid processing in a keypad, wherein the keypad having an auxiliary keyboard mode and a calculator mode therein and able to proceed with the rapid processing while being connected to an electronic device by the method comprising:
sending a predetermined meaning of a key code of the keypad to the electronic device depending on a state of the keypad;
responsive to pressing a mode switch key of the keypad to switch the keypad to the calculator mode, carrying out an operation of a calculator in the keypad; and
responsive to pressing a send key of the keypad, irrespective of the keypad being in the auxiliary keyboard mode or the calculator mode, sending a value shown on a display of the keypad to a current cursor's location on a display of the electronic device as the electronic device is running an application program.

2. The method of claim 1, wherein a circuitry of the keypad comprises:
a keyboard scanning matrix for receiving and performing a predetermined instruction;
a microprocessor for controlling a normal operation of the keypad and associated electronic elements in the keypad and sending the predetermined meaning of a key code of the keypad to the electronic device so that the electronic device is capable of operating normally;
a power control circuit for switching power of the keypad to either connect to the electronic device in response to a connection of the keypad and the electronic device or connect to an external power source in response to a disconnection of the keypad and the electronic device in which the keypad is allowed to perform the calculator mode only; and
an oscillation circuit for providing a timing clock to the microprocessor, the oscillation circuit being capable of increasing voltage by three times for supplying power to the display.

3. The method of claim 2, wherein responsive to connecting the keypad to the electronic device via an interface and a user's operation, the keypad is capable of perform the steps of:
in response to a detection of pressing the mode switch key to switch the keypad to the calculator mode by the microprocessor, receiving digit input and performing one of a plurality of operations;
in response to a detection of pressing the send key by the microprocessor, directly sending a result of the operation shown on the display to the current cursor's location as the electronic device is running the application program, thereby enabling a user to edit a document; and
in response to a determination of the mode switch key being not pressed to switch the keypad to the auxiliary keyboard mode by the microprocessor, performing a normal processing in the calculator mode.

4. The method of claim 3, wherein in response to the detection of the send key being not pressed by the microprocessor, the keypad is operative to maintain at the calculator mode.

5. The method of claim 3, wherein in response to the determination of the mode switch key being pressed to switch the keypad to the auxiliary keyboard mode by the microprocessor, the keypad is operative to enter into the auxiliary keyboard mode.

6. The method of claim 3, wherein in response to the detection of the mode switch key being pressed to switch the keypad to the auxiliary keyboard mode and the send key is determined to be pressed by the microprocessor, the value shown on the display of the keypad is directly sent to the current cursor's location as the electronic device is running the application program, thereby enabling a user to edit a document.

7. The method of claim 6, wherein in response to the detection of the mode switch key being pressed to switch the keypad to the auxiliary keyboard mode and the send key is determined to be not pressed by the microprocessor the keyboard scanning matrix is operative to receive a meaning of the pressed key code, the Number Lock key of the keypad is determined in an on state, and the Number Lock key of the keyboard of the electronic device is determined in an ON state, and the predetermined meaning of a key code is directly sent to the electronic device for normal processing.

8. The method of claim 7, wherein in response to the determinations of the Number Lock key of the keypad in an on state and the Number Lock key of the keyboard of the electronic device in an off state, the microprocessor is operative to send a predetermined meaning of the Number Lock key of the keypad to the electronic device for commanding the Number Lock key of the keyboard to be in a ready to receive state, send the predetermined meaning of the key code to the electronic device, and send the predetermined meaning of the Number Lock key of the keypad for causing the Number Lock key of the keyboard to return to its original state for normal processing.

9. The method of claim 7, wherein in response to the receiving of the meaning of the pressed key code by the keyboard scanning matrix and the determinations of the Number Lock key of the keypad in an off state and the Number Lock key of the keyboard of the electronic device in an off state, the microprocessor is operative to send the predetermined meaning of the key code to the electronic device for normal processing.

10. The method of claim 9, wherein in response to the receiving of the meaning of the pressed key code by the keyboard scanning matrix and the determinations of the Number Lock key of the keypad in an off state and the Number Lock key of the keyboard of the electronic device in an off state, the microprocessor is operative to send the predetermined meaning of the Number Lock key of the keypad to the electronic device for commanding the Number Lock key of the keyboard to be in a ready to receive state, send the predetermined meaning of the key code to the electronic device, and send the predetermined meaning of the Number Lock key of the keypad for causing the Number Lock key of the keyboard to return to its original state for normal processing.

11. The method of claim 3, wherein the sending of the predetermined meaning of the key code to the electronic device is done by a Universal Serial Bus (USB).

12. The method of claim 3, wherein the sending of the predetermined meaning of the key code to the electronic device is done by an IBM bus structure.
